(19) United States
(12) Patent Application Publication
(10) Pub. No.: US 2003/0009329 A1
(43) Pub. Date: Jan. 9, 2003

(54) Directionally sensitive audio pickup system with display of pickup area and/or interference source

(76) Inventors: Volker Stahl, Aachen (DE); Alexander Fischer, Aachen (DE)

Correspondence Address: U.S Philips Corporation, 580 White Plains Road, Tarrytown, NJ, 10591, US

(21) Appl. No.: 10/188,136

(22) Filed: Jul. 2, 2002

(30) Foreign Application Priority Data
Jul. 7, 2001 (DE) 10133126.6

(51) Int. Cl. G10L 15/00

(52) U.S. Cl. 704/233

(57) ABSTRACT

The invention relates to a directionally sensitive audio pickup system with a system component

for displaying a pickup area of the system and/or

for displaying an interference source.

In a preferred embodiment, an artificial creature or a part of an artificial creature serves for displaying the pickup area and/or the interference source. A stylized human head or canine design are suitable, for example.

An audio pickup system according to the invention is of particular importance as an integral part of a speech recognition system which may be used, for example, as a user interface for controlling devices.

The invention relates to a directionally sensitive audio pickup system and in particular to a speech recognition system, which uses such a directionally sensitive audio pickup system for registering speech commands. Such speech recognition systems can be used to advantage, for example, as user interfaces for controlling devices.

Directional sensitivity can be achieved in an audio pickup system, for example, by using a directional microphone or also by using a microphone array with appropriate signal processing. Here, the purpose of a directional characteristic is to accentuate the audio signals coming from the pickup area of the directionally sensitive audio pickup system with respect to all other audio signals. Compared with a microphone with an omnidirectional characteristic, therefore, the useful signals originating from the pickup area are boosted and/or the interference signals originating from outside the pickup area are attenuated, thereby improving the signal-to-noise ratio of the audio pickup system. In particular, the arrangements with a number of microphones, referred to as microphone arrays, afford great improvements in the signal compared to a single microphone.

The interference signals not coming from the pickup area may, on the one hand, come from signal sources situated outside the pickup area. However, they may also derive from the useful signal source itself, if its audio signals reach the microphones of the audio pickup system several times with corresponding phase displacements due to multipath propagation, following reflections on room walls, for example. So-called equalizers can, as a rule, still make effective use of such incoming phase-displaced signals, provided that the magnitude of the phase displacement lies within the working range of the equalizer.

If the path differences and hence the phase displacements of the audio signals arriving through multipath propagation are too great, however, or if the audio pickup system does not have an equalizer, the delayed audio signals act as interference signals on the useful signal source. If, however, the most recent deflection of these delayed audio signals prior to reception occurs at a point, such as a room wall, which is not situated in the pickup area of the audio pickup system, the directional characteristic of the audio pickup system also acts on these signals. To the audio pickup system, in fact, this most recent deflection point represents an apparent source of interfering audio signals and hence an interference source. In this respect audio pickup systems with directional characteristic can therefore also reduce the problems resulting from multipath propagation, which are also known as reverberation.

If the direct propagation path from the useful source to the microphones of the audio pickup system is blocked by an obstacle, for example, the most recent deflection point in the propagation path seems to the audio pickup system to be an apparent useful source, arrived at by the strongest of the signals reaching it via the various propagation paths. As a rule, an audio pickup system will regard these apparent sources as the actual signal sources. In principle, however, an appropriately equipped system would be capable, if the propagation conditions were known, of tracing the propagation paths back and thus of identifying the actual locations of the audio sources.

If a linear microphone array is used, for example, the pickup area of a directionally sensitive audio pickup system may be a specific direction in the room, which to use the English term is referred to as a “beam”. Using other microphone arrangements, however, such as ones situated in one plane, for example, it is also possible to produce differently formed pickup areas. In particular, by using three-dimensional arrangements, the pickup area may also be limited to a specific, more restricted area of the room, resulting in great signal improvements.

Since in the case of microphone arrays the pickup area can be influenced by the subsequent signal processing, the shape and position of the pickup areas of these systems can be adapted with particular flexibility. Furthermore, the pickup area can naturally also be influenced by mechanical movement of the microphone or microphones. On the other hand, such a control of the pickup area may also be used to locate a signal source, that is to say, depending on the system design, to determine the direction or even the more restricted area of the room in which the signal source is situated. The pickup area may also be made to track a moving signal source, in order to obtain an optimum signal-to-noise ratio throughout the entire audio pickup session.

Directionally sensitive audio pickup systems have therefore found a number of applications. For example, they ensure a high pickup quality for newsreaders and speakers, or they serve for picking up and simultaneous “tracking” of the current speaker in audio and video conferencing. In the latter, that is to say video conferencing, the “tracking” signals may be used to simultaneously control the pickup area of the video camera(s). The video signals may also be used after an appropriate sample processing, for “tracking” the speaker.

The use of directionally sensitive audio pickup systems is of particular importance for the registering of speech commands in speech recognition systems. It is known that the recognition accuracy of a speech recognition system deteriorates considerably with a diminishing signal-to-noise ratio. For this reason, high-quality pickup systems, as represented by directionally sensitive audio pickup systems, for example, are of particular importance for speech recognition systems.

Thus, WO 01/29823 A1 describes a natural language interface control system for operating a plurality of devices, the speech of the user being picked up by a microphone array, to be then fed to a speech recognition system (comprising a feature extraction module and a speech recognition module) and further processing stages (natural language interface module). In this processing chain, the natural language expressions of the user are finally translated into commands, which then control devices connected through a device interface. As was noted above, the function of a directionally sensitive audio pickup system is to boost the audio source(s) in their pickup area and/or to attenuate them outside their pickup area, so as to obtain an improved signal-to-noise ratio compared with a microphone with an omnidirectional characteristic. It is therefore essential in a directionally sensitive audio pickup system that an audio source to be picked up be actually situated in the pickup area of the system. Otherwise the signal-to-noise ratio may be so poor that the audio pickup becomes unusable. This is the case in particular if the directionally sensitive audio pickup system feeds a speech recognition system.

In order then to actually focus on a desired audio source, directionally sensitive audio pickup systems may be equipped with a tracking function, as was noted above. In particular, the directional characteristic of the system itself may be used, or use is made of additional information sources, such as video cameras, for example. Nevertheless, the desired audio source may be situated outside the pickup area of the directionally sensitive audio pickup system.

For example, the following situation is conceivable: a person wishes to operate a video recorder by means of a natural language user interface described in WO 01/29823 A1. In the same room as this person, however, there are two other persons talking to one another. The audio pickup system may then erroneously focus on these two other persons, which will mean that the commands of the first person are attenuated by the audio pickup system, whilst the conversation of the two other persons is boosted. The speech recognition system connected on the output side then largely “hears” only the conversation of the two other persons, from which it infers either no commands or even commands understood in error. In this situation the first person has no possibility of operating the video recorder via the user interface, and is astonished and possibly even annoyed at the faulty reactions of the user interface and of the video recorder.

In such a situation or a similar one, however, a further problem may also arise. For example, the pickup of the desired audio source may also be unusable if the desired audio source is situated in the pickup area of the directionally sensitive audio pickup system but the interference from the other audio sources is too great, despite the fact that these are situated outside the pickup area. This occurs, for example, when the interfering audio sources are too strong, are situated far closer to the microphones than the desired audio source, or when the directionally sensitive audio pickup system is of inferior quality, so that it does not produce an adequate improvement of the signal-to-noise ratio. In this case, too, a user will be at a loss to explain the erratic behavior of the system.

The invention accordingly has for its object to enable a user of a directionally sensitive audio pickup system to account for the behavior of the system and to influence it in accordance with his wishes.

The object is achieved by a directionally sensitive audio pickup system having a system component

for displaying a pickup area of the system and/or

for displaying an interference source.

Equipping the directionally sensitive audio pickup system with a system component which displays for a user the pickup area of the system and/or any interference sources provides the user with the information that he needs in order to understand the system behavior and be able to influence it according to his wishes.

If the system indicates to him, for example, that he is not in the pickup area, he can move into the pickup area indicated by the system, for example, or he can focus the attention of the system on himself, so that the system shifts its pickup area on to him. In order to excite the attention of the system, the user may, depending on the system design, clap his hands, for example, in order to utilize the directional characteristic of the audio pickup system, or he may wave vigorously in order to address the image processing component of a video system.

If the user wants the system to pick up another audio source rather than himself, he may direct the attention of the audio pickup system to this desired audio source. To do this, he may move towards this audio source, for example, and briefly clap his hands, before unobtrusively distancing himself again. Given an appropriate system equipment, however, a mere movement of the hand pointing to the desired audio source will suffice. This hand movement can then be picked up by a video camera, evaluated by image recognition and converted into a suitable control of the directional characteristic of the audio pickup system.

If the system indicates an interference source to him, such as a radio that is playing, he may in this example remove the interference by switching off the radio. Alternatively, however, he may improve the signal-to-noise ratio in respect of this interference source by speaking louder or getting closer the pickup system. If he is unable to counteract the interference, he still has the possibility, given a suitable system design, of resorting to another input medium, such as operating a video recorder by pressing corresponding appropriate keys

According to the dependent claims 2 to 5, the pickup area and/or interference source can be displayed by different ways ands means, which may also be combined with one another. Thus it is possible, for example, to insert a textual and/or graphic designation on a display. For example, the word “Couch”, a sketch of a couch and/or an image of the actual couch may be shown. Alternatively or in addition thereto, the word “Couch” may be emitted acoustically via a loudspeaker. Whether the couch is a pickup area or the site of an interference source may likewise be announced acoustically or represented graphically. Given the presence of a camera and a corresponding image recognition, it is also feasible to designate not only the site of the interference source, but the interference source itself, for example by emitting the phrase: “The radio in the right-hand corner is causing interference” over a loudspeaker.

Another possible method of displaying the pickup area and/or interference source is an indicating device, such as an arrow-shaped pointer, the tip of which points into the pick-up beam of a linear microphone array. By equipping the pointer with an alternatively lit red or green LED, it is possible to distinguish between pickup area and interference source, for example. Multiple indicating devices may be combined for indicating more restricted room areas.

Such indicating devices can be made particularly vivid by giving them the appearance of artificial creatures or the limbs of such artificial creatures. Thus an artificial arm or an artificial head may be used, for example. With an artificial head it is possible to achieve a particularly expressive display by means of the line of sight of artificial eyes. Instead of parts of artificial creatures, complete artificial creatures may also be used. Thus an artificial dog may turn entirely in the direction to be indicated and it may indicate more restricted areas of the room by moving its head and the line of sight of its eyes. Moreover, a suitable psychological impression of the automatic system can be created in the user's mind through the choice of artificial creature: stupid/clever, subservient/objective system.

Instead of designing a physical indicating device, it is also possible to merely represent this graphically on a display. Thus an arrow may be depicted in perspective and an artificial creature may be represented on a display screen. Although such a graphic representation does not have the same impact as an actual physical format, it does increase the flexibility and maintainability of the system and reduces the cost of manufacture and upkeep.

The dependent claims 6 and 7 relate to embodiments of a directionally sensitive audio pickup system according to the invention in which the directional characteristic is achieved by means of a directional microphone and/or a microphone array.

In the independent claims 8, 9 and 10, however, the invention also relates to a speech recognition system which obtains its audio signals from an audio pickup system according to the invention, to a control system which uses such a speech recognition system as a user interface, and to a device that is operated by means of such a control system. As was mentioned above, speech recognition systems in particular are reliant upon high-quality audio pickup systems and are especially suitable as user interface for operating devices because of the naturalness of speech communication. In this respect, speech recognition systems, control systems, and devices controlled thereby will benefit especially from the invention. Such systems may be used in particular for the operation of appliances in the home, such as entertainment electronics appliances or domestic appliances. The same applies to devices in the car such as a radio or a navigation system, which the driver perhaps wishes to operate at a moment when the other occupants of the car are conversing. For this purpose, such control systems with speech recognition can also be integrated into these devices.

The invention will be further described with reference to embodiments shown in the drawings, to which, however, the invention is not limited, and in which:

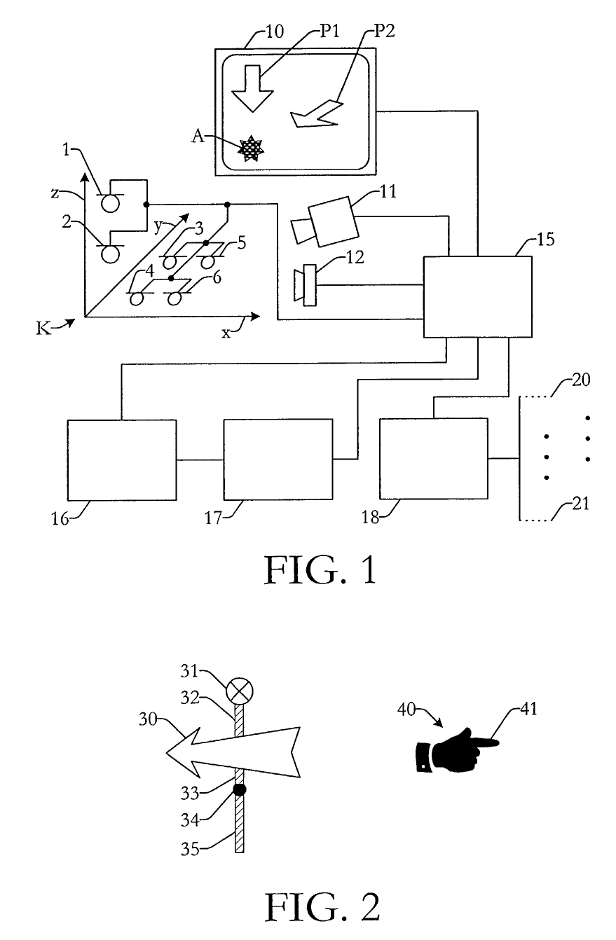

FIG. 1 shows an embodiment of the control system according to the invention with a speech recognition system having a directionally sensitive audio pickup system,

FIG. 2 shows two embodiments of an indicating device, and

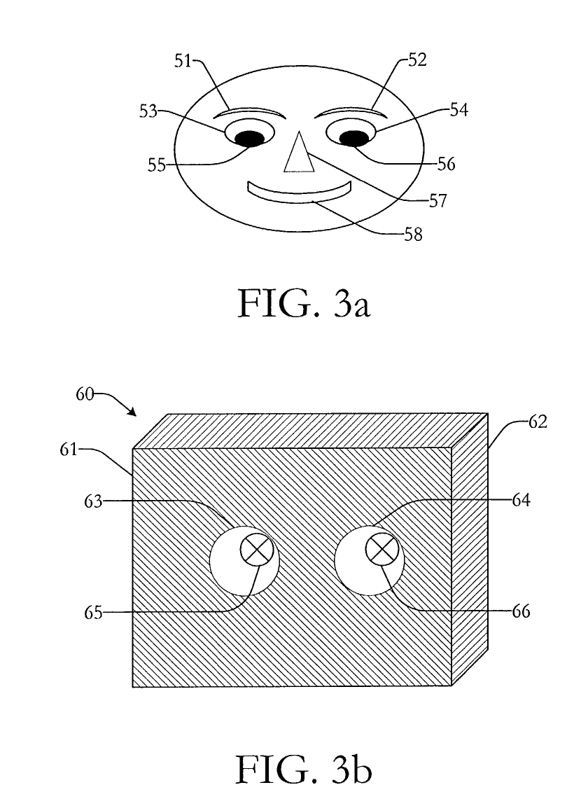

FIGS. 3a, 3b show two embodiments of an indicating device having a “pair of eyes”.

FIG. 1 is a diagrammatic representation of an embodiment of the control system according to the invention, having a speech recognition system with a directionally sensitive audio pickup system. In order to indicate the position in the room of the microphones 1 to 6 of the audio pickup system, FIG. 1 shows a Cartesian system of coordinates K with the orthogonal axes x, y, and z. The two microphones 1 and 2 form a linear microphone array parallel to the direction z. The remaining microphones 3 to 6 are arranged in a flat microphone array in the x-y-plane. Together the microphones 1 to 6 therefore form a three-dimensional microphone array.

The audio signals picked up by the microphones 1 to 6 are fed to a monitoring and control unit 15, which through appropriate signal processing defines the pickup area of the microphone array. In so doing, the monitoring and control unit 15 endeavors to define the pickup area in such a way that the desired audio sources are situated in the pickup area. In order to achieve this objective, it also operates a video camera 11, which is likewise coupled to the monitoring and control unit 15. In addition to evaluating the audio signals supplied by the microphones 1 to 6, the monitoring and control unit 15 can therefore also perform a sample recognition on the video signals of the video camera 11 in order to determine the positions of the desired audio sources.

A display 10 and a loudspeaker 12 are connected to the monitoring and control unit 15 as output media. The user of the system can be given reports on the system behavior via the output media and he can be asked for further inputs. In particular, however, said media may also be used in order to indicate the pickup area of the microphone arrays formed from the microphones 1 to 6 and/or the direction and/or the position of interference sources. For this purpose a text, which designates the pickup area and/or interference source can be outputted graphically via the display 10 or acoustically over the loudspeaker 12. Possible texts are “Pickup area: Couch”, “The pickup direction is 20 degrees left of the appliance”, “The radio behind on the left is causing interference” or “Interference from the device on the right”.

In addition to or instead of a text, a graphic representation may be used on the display 10. Thus a stylized figure of a couch may be shown if the pickup area is located there. It is also possible, however, to display an actual image of the pickup area and/or the interference source in that the system orients the video camera 11 towards this and reproduces its image on the display 10. For some of these outputs, for example in order to be able to display the text “Couch”, the system must feed the video signal from the video camera 11 to a corresponding image recognition. If the system does not possess this facility, it may be limited to indirect information such as the room direction relative to the pickup unit for indicating the pickup area and/or interference source.

A further display possibility is indicated in FIG. 1 by the representation of the two indicator arrows P1 and P2 and the pickup area symbol A on the display 10. The indicator arrows P1 and P2 are represented in distorted perspective on the display 10 and inform the user, when he looks at the display 10, what position the system is seeking to indicate to him. The pickup area symbol A indicates to him that the pickup area of the system is located in this position. If the system focuses solely on one pickup direction instead of a more restricted position in the room, a single indicator arrow suffices for the display, whereas two or more arrows may be used for a more precise display of a room position. If an interference source is to be displayed instead of the pickup area, an interference source symbol, such as a stylized flash, for example, is displayed instead of the pickup area symbol A.

The monitoring and control unit 15 relays the focused audio signal from the microphone array to the speech recognition system 16, which translates this into text and forwards it to the comprehension component 17. From the natural language text, the comprehension component 17 extracts those constituents that are relevant to control of the device, that is, for example, the designation of the device to which the command relates, the command and, where applicable, the command parameters. From the natural language sentence “Switch the television to CNN” the comprehension component 17 then extracts the fact that the television is to be controlled, that it involves changing the channel received, and that the new channel is to be the station CNN.

The comprehension component 17 returns the result to the monitoring and control unit 15. The latter verifies whether all information has been given in order to be able to perform the action desired by the user. If this is the case, the corresponding commands are relayed to the device interface 18, which finally translates them into commands specific to the device and relays them to the device connected to the device interface 18 via one of the leads 20 . . . 21. Should information still be missing, however, the monitoring and control unit 15 informs the user of this via the display 10 and/or the loudspeaker 12 and asks him for further inputs.

In addition to missing and ambiguous information, the monitoring and control unit 15 can also issue queries if the recognition of the user statement has a reduced reliability, which the speech recognition system 16 and/or the comprehension component 17 can determine, for example, by calculating confidence levels. If, in the example above therefore, the station name CNN has been imperfectly understood, i.e. it has only a low reliability, the monitoring and control unit 15 may ask the user to repeat once again the station name to which the channel is to be switched.

The object of the monitoring and control unit 15 in respect of the invention is, in particular, to keep the user as the desired audio source in the pickup area of the microphone array formed by the microphones 1 to 6 and to detect any interference sources. If the recognition performance declines, for example, which the system recognizes through a decrease in the comprehension confidence levels and/or more frequent queries to the user and corrections by the user, it can bring this fact to the attention of the user and display the pickup area of the system for him. With the aid of the microphone array and/or the camera 11, it can furthermore search the room for interference sources, in order likewise to display these to the user. The user may then take appropriate countermeasures. He may, for example, move back into the pickup area or bring the pickup area to him by clapping his hands, in order to direct the attention of the system to himself. He may also switch off the interference sources.

Instead of indicating the pickup area and the interference sources to the user in the event of low reliability of the recognition results only, the system may also do this continuously or only at periodic intervals. In addition, the directional characteristic of the microphone array and/or the video signals supplied by the camera 11 may also be used for tracking the user and focusing on him. With suitable equipment, the microphones 1 to 6 of the microphone array and/or the camera 11 may also be made to track the user through a suitable adjustment of their positions and orientations.

FIG. 2 shows two further embodiments of an indicating device. For indicating the direction of the pickup area and/or interference source, the system may use an arrow 30 which is supported by a rod 33 and a spherical joint 34 so that it can rotate in all directions on a foot 35. A lamp or luminous electrode 31 may be fitted to the arrow 30 by means of a further rod 32. It can then be indicated via the color and/or the illumination pattern of this lamp 31 whether the indicator device is active and whether it indicates the pickup area or an interference source. For example, the lamp 31 switched off may indicate that the indicating device is inoperative, green may can indicate that the pickup area is indicated, and red that an interference source is indicated. Instead of the arrow 30, any other form of indicating device readily perceivable to the user may be used. As an example, FIG. 2 also shows a hand 40 with extended index finger 41 which indicates the direction.

If not only a direction but a more restricted room area is to be indicated, a number of such arrows 30 or the like may again be combined. Instead of a mechanical design of the arrows 30, it is also possible, as shown in FIG. 1, to merely represent this pointer in perspective on a display 10.

FIGS. 3a and 3b show two further embodiments of an indicating device, which both feature a pair of eyes. In FIG. 3a, the head designed to resemble a human head represents an artificial creature which has two eyebrows 51 and 52, two eyes 53 and 54 each with a pupil 55 and 56, a nose 57, and a mouth 58. It is possible to give an observer the impression that the artificial creature is “looking” into a certain area of the room by means of a suitably designed shape of the eyes 53 and 54 and in particular the pupils 55 and 56.

Whether this area of the room is the pickup area of the system or an interference source may be suggested by the shape of the mouth 58 and/or that of the eyebrows 51, 52 and/or also that of the nose 57. The expression of the face shown in FIG. 3 denotes, for example, that the artificial creature is looking at the pickup area. Lowered corners of the mouth, raised eyebrows 51, 52, or a wrinkled nose 57 on the other hand could be indicative of an interference source. Inactivity of the system can be suggested by an absent gaze into the distance, or the eyes 53, 54 might also be drawn with eyelids not shown in FIG. 3a, which would then be closed.

FIG. 3b shows a simplified “pair of eyes” 63, 64 with “pupils” 65, 66. Two holes 63 and 64 are cut in the front wall 61 of a box 60. Standing vertically or almost vertically in front of the front wall 61, one can discern through the holes 63, 64 two lamps or LEDs 65, 66 mounted inside on the rear wall 62 of the box 60. If the user can see these LEDs 65, 66 in the center of the holes 63, 64, he is precisely in the “line of sight” of the system. If the LEDs 65, 66 migrate from the center of the holes 63, 64, he departs from the line of sight. Whether the line of sight relates to the pickup direction or the direction of an interference source may again be distinguished, for example, from the color of the LEDs 65, 66; for example green for the pickup direction and red for an interference source. Inactivity of the system may be characterized, for example, by switching off of the LEDs 65, 66.

1. A directionally sensitive audio pickup system having a system component
for displaying a pickup area of the system and/or
for displaying an interference source.

2. A directionally sensitive audio pickup system as claimed in claim 1, characterized in that
the pickup area and/or the interference source are displayed through an acoustic and/or textual and/or graphic designation of the pickup area and/or the interference source.

3. A directionally sensitive audio pickup system as claimed in claim 1, characterized in that
the system component for displaying the pickup area and/or the interference source comprises an indicating device, which is designed for indicating the pickup area and/or the interference source by pointing towards it.

4. A directionally sensitive audio pickup system as claimed in claim 1, characterized in that
the system component for displaying the pickup area and/or the interference source comprises an artificial creature or part of an artificial creature, which are designed for indicating the pickup area and/or the interference source by pointing and/or by looking towards it.

5. A directionally sensitive audio pickup system as claimed in claim 1, characterized in that
the pickup area and/or the interference source are displayed through the graphic representation of an indicating device as claimed in claim 3 or an artificial creature or a part of an artificial creature as claimed in claim 4.

6. A directionally sensitive audio pickup system as claimed in claim 1, characterized in that
a directional microphone for achieving directional sensitivity forms part of the audio pickup system.

7. A directionally sensitive audio pickup system as claimed in claim 1, characterized in that
a microphone array (1 to 6) for achieving directional sensitivity forms part of the audio pickup system.

8. A speech recognition system having a directionally sensitive audio pickup system with a system component
for displaying a pickup area of the system and/or
for displaying an interference source.

9. A control system with a speech recognition system having a directionally sensitive audio pickup system with a system component
for displaying a pickup area of the system and/or
for displaying an interference source.

10. A device, particularly in the home or in the car, having a control system with a speech recognition system having a directionally sensitive audio pickup system with a system component
for displaying a pickup area of the system and/or
for displaying an interference source.
